(19) United States
(12) Patent Application Publication
(10) Pub. No.: US 2012/0242693 A1
(43) Pub. Date: Sep. 27, 2012

(54) IMAGE SYNTHESIS DEVICE AND IMAGE SYNTHESIS PROGRAM

(75) Inventors: Masaki Hamada, Tokyo (JP); Yoshiyuki Kato, Tokyo (JP); Akira Torii, Tokyo (JP); Ryohei Ishida, Tokyo (JP); Takafumi Kasuga, Tokyo (JP)

(73) Assignee: Mitsubishi Electric Corporation, Tokyo (JP)

(21) Appl. No.: 13/513,872

(22) PCT Filed: Dec. 11, 2009
(86) PCT No.: PCT/JP2009/006807

§ 371 Date: Jun. 5, 2012

(51) Int. Cl. G09G 5/00

(52) U.S. Cl. 345/629

(57) ABSTRACT

An image synthesis device includes a matrix memory for storing matrix information for bringing subregions of each of inputted images into correspondence with subregions of an outputted image, and a vector graphic processing unit for drawing a vector graphic of each of graphic regions according to graphic data in a vector form defined by both vertex data for defining the shape of each of the graphic regions into which the outputted image is divided, and a drawing command for specifying contents-to-be-drawn of the vertex data, and performs a coordinate transformation process on the vector graphic by using a correspondence defined by the matrix information to calculate texture coordinates of the inputted images, and displays synthesized image data which the image synthesis device calculates by using image element data about the inputted images, the image element data corresponding to the texture coordinates, as the outputted image.

### FIELD OF THE INVENTION

The present invention relates to an image synthesis device which receives image data acquired by capturing actual images viewed from a plurality of viewpoints, and which performs a viewpoint transformation on each of the images to create a synthesized image, and an image synthesis program for causing a computer to function as this image synthesis device.

### BACKGROUND OF THE INVENTION

Conventionally, an image processing device which converts an image inputted from an image capturing unit for capturing an actual image into a virtual image which is viewed from a predetermined virtual viewpoint has been used widely.

For example, an image processing device disclosed by patent reference 1 is provided with a mapping table for bringing the image element positions of an outputted image into correspondence with the image element positions of an inputted image in order to simplify the creation of a virtual image. More specifically, in addition to a relationship between the pixel coordinate positions (u, v) of a virtual camera and the pixel coordinate positions (U, V) of each real camera, the image processing device disclosed by patent reference 1 records the identifier of each real camera, and the necessity degree of each camera and so on in a case in which a pixel coordinate position of the virtual camera corresponds to those of a plurality of real cameras in the mapping table as needed.

Further, when one image element position of the outputted image corresponds to a plurality of image element positions of the inputted image, the image processing device can also synthesize the pixel values at the plurality of image element positions according to the necessity degree of each pixel to which the image processing device refers at the same time when the image processing device refers to the image element positions of the inputted image.

Because the conventional image processing device is constructed as above, the conventional image processing device can easily acquire a relationship between the image element positions of the outputted image and the image element positions of the inputted image.

A problem is, however, that because it is necessary to store required information in the mapping table in units of one pixel, the memory size increases.

The present invention is made in order to solve the above-mentioned problem, and it is therefore an object of the present invention to provide an image synthesis device which can easily acquire a relationship between the image element positions of an outputted image and the image element positions of an inputted image while reducing the memory capacity without using a mapping table for each pixel, and an image synthesis program for causing a computer to function as this image synthesis device.

### RELATED ART DOCUMENT

### Patent Reference

Patent reference 1: Japanese Unexamined Patent Application Publication No. 2008-48266

### SUMMARY OF THE INVENTION

In accordance with the present invention, there is provided an image synthesis device including: an image input unit for capturing a plurality of images inputted thereto; an image memory for storing the inputted images captured by the image input unit; a matrix memory for storing matrix information for bringing subregions of each of the inputted images into correspondence with subregions of an outputted image in units of one graphic which forms the subregions; a vector graphic processing unit for receiving graphic data in a vector form defined by both vertex data for defining a shape of each of a plurality of graphic regions into which the outputted image is divided, and a drawing command for specifying contents-to-be-drawn of the vertex data, and for drawing a vector graphic of each of the graphic regions according to the graphic data; an image synthesis unit for performing a coordinate transformation process on the vector graphic drawn by the vector graphic processing unit by using a correspondence defined by the matrix information read from the matrix memory to calculate texture coordinates of the inputted images, and for calculating synthesized image data about synthesis of the inputted images and the outputted image by using image element data about the inputted images, the image element data being read from the image memory and corresponding to the texture coordinates; a display memory for storing the synthesized image data calculated by the image synthesis unit; and a display control unit for displaying the synthesized image data read from the display memory on a screen of a display unit as the outputted image.

The image synthesis device according to the present invention includes the matrix memory for storing the matrix information for bringing the subregions of each of inputted images into correspondence with the subregions of an outputted image in units of one graphic which forms the subregions, and the vector graphic processing unit for receiving graphic data in a vector form defined by both vertex data for defining a shape of each of a plurality of graphic regions into which the outputted image is divided, and a drawing command for specifying contents-to-be-drawn of the vertex data, and for drawing a vector graphic of each of the graphic regions according to the graphic data, and performs a coordinate transformation process on the vector graphic drawn by the vector graphic processing unit by using a correspondence defined by the matrix information read from the matrix memory to calculate texture coordinates of the inputted images, and displays synthesized image data which the image synthesis device calculates by using image element data about the inputted images, the image element data corresponding to the texture coordinates, on the screen of the display unit as the outputted image.

By thus carrying out the image synthesis using the matrix information for bringing the subregions of the outputted image into correspondence with the subregions of each inputted image, the image synthesis device provides an advantage of being able to reduce the memory capacity as compared with a case in which a mapping table in units of one pixel is used.

### BRIEF DESCRIPTION OF THE FIGURES

FIG. 1 is a block diagram showing the structure of an image synthesis device in accordance with Embodiment 1 of the present invention;

FIG. 2 is a view showing an example of graphic data in a vector form;

FIG. 3 is a view showing an example of region division of an outputted image;

FIG. 4 is a view showing an example of a correspondence between subregions of the outputted image and subregions of each inputted image;

FIG. 5 is a flow chart showing a flow of the operation performed by the image synthesis device in accordance with Embodiment 1; and

FIG. 6 is a flow chart showing a flow of the operation performed by an image synthesis device in accordance with Embodiment 2 of the present invention.

### EMBODIMENTS OF THE INVENTION

Hereafter, in order to explain this invention in greater detail, the preferred embodiments of the present invention will be described with reference to the accompanying drawings.

### Embodiment 1

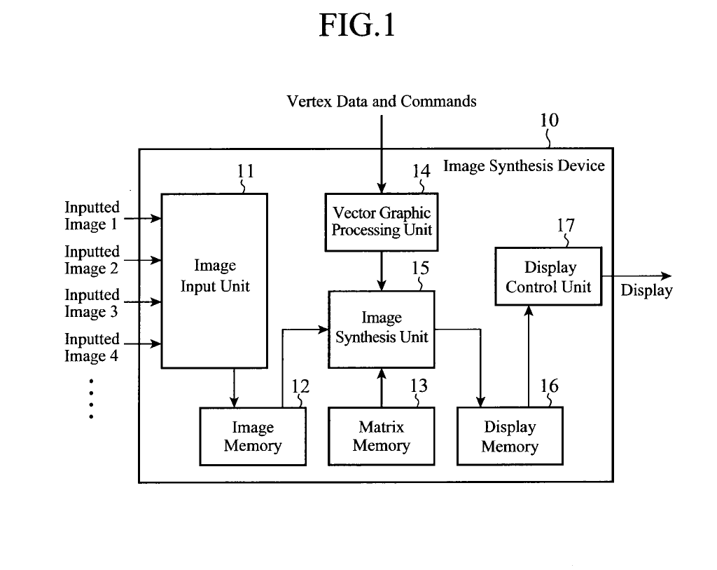

FIG. 1 is a block diagram showing the structure of an image synthesis device in accordance with Embodiment 1 of the present invention. In FIG. 1, the image synthesis device 10 in accordance with Embodiment 1 is provided with an image input unit 11, an image memory 12, a matrix memory 13, a vector graphic processing unit 14, an image synthesis unit 15, a display memory 16, and a display control unit 17. The image input unit 11 is a component for selecting image data to be captured from among a plurality of inputted images (each of which is a still image or a moving image) 1, 2, 3, 4, and . . . , and writing the image data selected thereby in the image memory 12. For example, the image input unit 11 can be constructed in such a way as to have multiple line temporary buffers for temporarily storing the image data.

The matrix memory 13 is a storage unit for storing matrix information for bringing subregions of each of the inputted images selected into correspondence with subregions of an outputted image. The matrix memory holds the matrix information in units of one graphic which forms the subregions. When the relationship between the outputted image and each of the inputted images is uniquely determined in advance, the image synthesis device calculates the matrix information only once before starting image synthesis, and simply stores the matrix information which is the calculation result in the matrix memory 13, so that the image synthesis device does not have to change the matrix information during the image synthesis. Further, when switching between two or more relationships each between an inputted image and the outputted image to use them, the image synthesis device stores matrix information corresponding to each scene in the matrix memory 13 in advance, and switches between the two or more relationships to determine which matrix information to use at the time of image synthesis, thereby being able to also support a change of viewpoint.

The vector graphic processing unit 14 is a component for receiving graphic data in a vector form inputted thereto and defined by both vertex data acquired as a result of dividing the outputted image (display screen) into a plurality of regions, and a series of commands which consist of drawing commands for specifying the contents-to-be-drawn using the vertex data to create vector graphics on the basis of the graphic data.

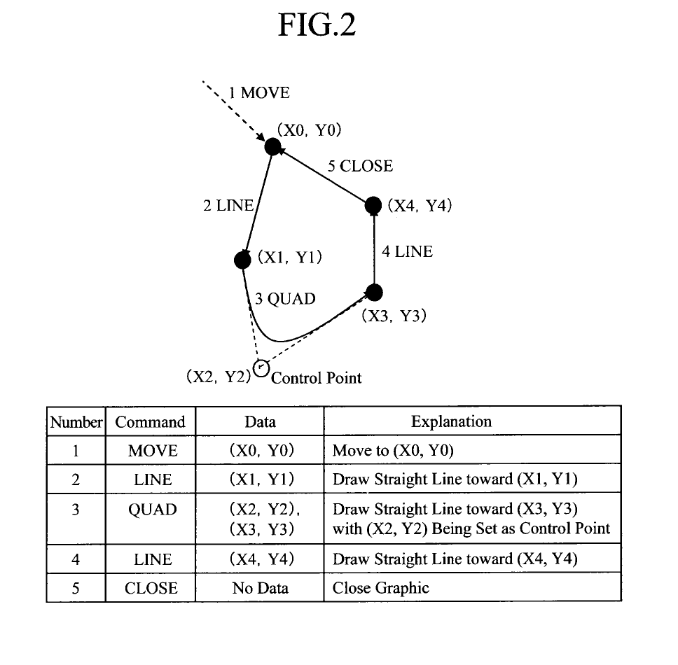

FIG. 2 is a view showing an example of the graphic data in a vector form. In the example of FIG. 2, vertex data corresponding to five drawing commands form a graphic. When drawing a curved line, the image synthesis device draws the curved line by specifying an end point and a control point of the graphic.

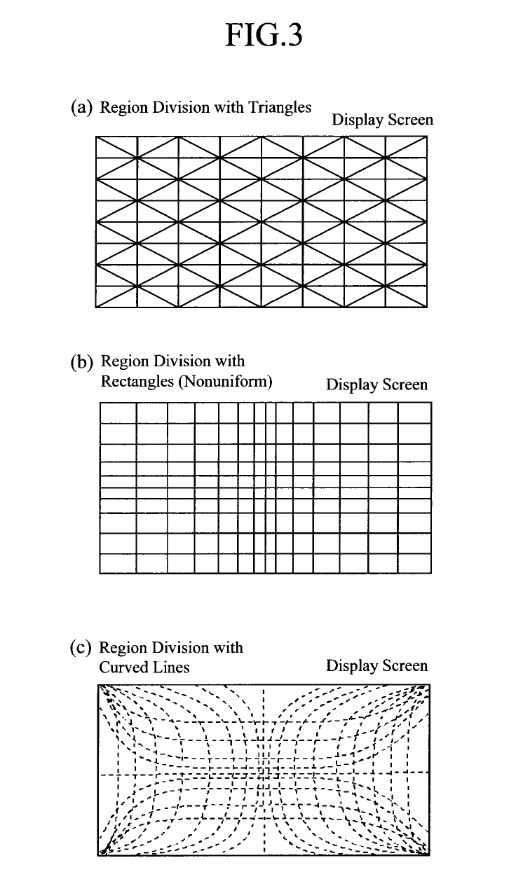

In this case, the region division is not limited to a typical one which uses triangles (refer to FIG. 3(a)) or rectangles (refer to FIG. 3(b)), as shown in FIG. 3, and the outputted image can be divided into regions by using vector graphics each including a curved line as a part of its outline (refer to FIG. 3(c)). For example, when an inputted image is an input from a wide angle camera with large distortion, the image synthesis device can suppress the influence of the lens distortion of the camera by dividing the outputted image (display screen) into regions by using vector graphics.

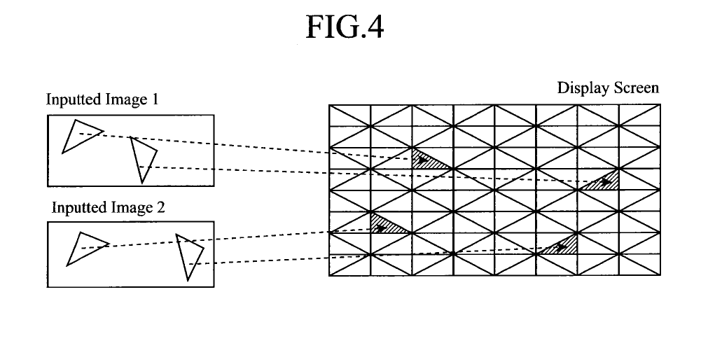

FIG. 4 is a view showing an example of a correspondence between subregions of the outputted image stored in the matrix memory 13, and subregions of inputted images. For example, in a case in which triangular regions of inputted images correspond to triangular regions of the outputted image (display screen), respectively, as shown in FIG. 4, the correspondence between them can be expressed as a 2×3 matrix, as follows.

In this case, the element at the i-th row and j-th column of the transformation matrix is expressed as Mij, and a point (X, Y) in each of the inputted images corresponds to a point (X′, Y′) of the outputted image. X′ and Y′ have a relationship given by the following equation (1). The vector graphic processing unit 14 determines a region included in each vector graphic, and outputs the X and Y coordinates of each pixel to be drawn to the image synthesis unit 15.

X′=(M00·X+M01·−Y+M02)

Y′=(M10·X+M11·Y+M12) (1)

The image synthesis unit 15 carries out a predetermined coordinate transformation process on the image stored in the image memory 12 by using the information stored in the matrix memory 13, and carries out texture mapping on each vector graphic by using the result of the predetermined coordinate transformation process. The image synthesis unit 15 also calculates a physical memory address and drawing data (drawing color) corresponding to each pixel to be drawn, and stores them in the display memory 16. Because the transformation matrix (matrix information) provided not for each pixel but for each graphic is stored in the matrix memory 13, the image synthesis unit 15 calculates texture coordinates by interpolation for each pixel within each vector graphic. The display control unit 17 reads data from the display memory 16, and creates a synchronization signal which complies with each display unit, such as an LCD or a liquid crystal display, to produce a screen display.

In the example of FIG. 1, it is assumed that each of the image input unit 11, the image memory 12, the matrix memory 13, the vector graphic processing unit 14, the image synthesis unit 15, the display memory 16, and the display control unit 17 consists of hardware for exclusive use, such as a semiconductor integrated circuit substrate on which an MPU (Micro Processing Unit) is mounted. However, the present invention is not limited to this structure.

For example, by storing an image synthesis program in which the process descriptions of the image input unit 11, the image memory 12, the matrix memory 13, the vector graphic processing unit 14, the image synthesis unit 15, the display memory 16, and the display control unit 17 which construct the image synthesis device 10 are described in a memory of a computer, and causing a CPU (Central Processing Unit) of the computer to execute the image synthesis program stored in the memory, the image synthesis device can be implemented as the components 11 to 17 each of which is provided by hardware and software working in cooperation with each other on the computer.

For example, the computer can be a personal computer. As an alternative, the computer can be a mobile phone, a mobile information terminal, a car navigation device, or the like which can execute the image synthesis program as will be mentioned below.

Next, the operation of the image synthesis device will be explained.

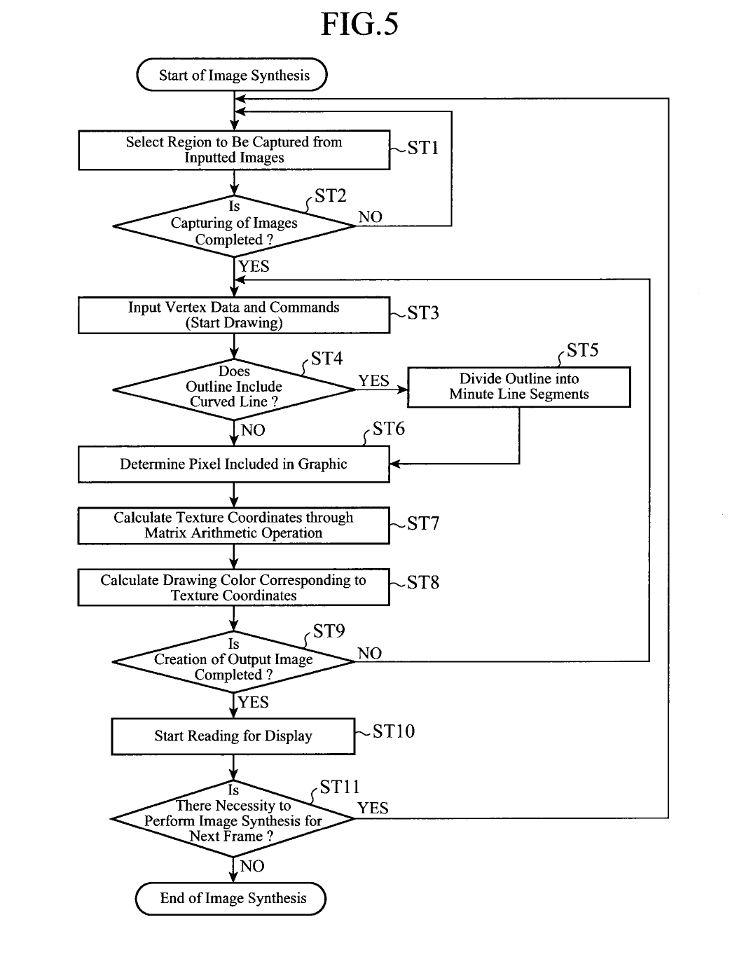

FIG. 5 is a flow chart showing a flow of the operation of the image synthesis device in accordance with Embodiment 1. The details of the image synthesizing processing in accordance with Embodiment 1 will be described with reference to this flow chart.

First, the image synthesis device 10 starts the operation in response to a synthesizing processing start command from a CPU of a system in which the image synthesis device 10 is mounted. The image synthesis device needs to set up the contents of the matrix memory 13 in advance before starting the operation.

When the image synthesis device receives the above-mentioned synthesizing processing start command, the image input unit 11 selects image data to be captured from among inputted images (each of which is a still image or a moving image) 1, 2, 3, 4, and . . . , and stores the image data selected thereby in the image memory 12 (step ST1). The image input unit 11 repeatedly performs the process of step ST1 until completing the capturing of all images to be synthesized (step ST2).

When the image input unit 11 completes capturing all the images to be synthesized, the vector graphic processing unit 14 receives the graphic data in a vector form which are defined by both vertex data and a series of commands and starts drawing each vector graphic (step ST3). At this time, the vector graphic processing unit 14 determines whether the outline of the vector graphic includes a curved line (step ST4). When the outline of the vector graphic includes a curved line (when YES in step ST4), the vector graphic processing unit 14 divides the outline into minute line segments (step ST5).

When the outline does not include a curved line (when NO in step ST4), or after, in step ST5, dividing the outline into minute line segments, the image synthesis device can easily determine a region included in the vector graphic by using a typical method of determining whether or not a point is included in a graphic because the outline of the vector graphic is constructed of only straight lines. Therefore, the vector graphic processing unit 14 calculates the X and Y coordinates of each pixel included in the vector graphic, and outputs these X and Y coordinates to the image synthesis unit 15 (step ST6).

The image synthesis unit 15 reads the matrix information corresponding to the graphic currently being drawn from the matrix memory 13, and carries out a coordinate transformation on the X and Y coordinates (X, Y) of each pixel inputted from the vector graphic processing unit 14 according to the following equation (2) (step ST7). As a result, the image synthesis unit acquires texture coordinates (U, V) of the inputted image. In this case, the transformation matrix has three rows and three columns, and the element at the i-th row and the j-th column of the matrix is expressed as Mij. In the following equation (2), the reason why division by W is performed on the texture coordinates is perspective correction. Because the coordinate transformation is a normal affine one when the third row of the transformation matrix is M20=M21=0 and M22=1, there is no necessity to perform the division by W on the texture coordinates.

U=(M00·X+M01·Y+M02)/W

V=(M10·X+M11·Y+M12)/W

W=M20·X+M21·Y+M22 (2)

The image synthesis unit 15 then reads the pixel of the inputted image corresponding to the texture coordinates (U, V) from the image memory 12, and determines a physical memory address and drawing data (drawing color) corresponding to the pixel to be drawn and stores the physical memory address and the drawing data in the display memory 16 (step ST8). At this time, the image synthesis unit can read two or more pixels of each inputted image, and carry out a filtering process, such as bilinear, on the pixels.

In this case, because the image synthesis device 10 according to the present invention assumes that the image synthesis device receives a plurality of inputted images, the image synthesis device needs to determine to which inputted image the texture coordinates (U, V) correspond.

To this end, for example, an identifier showing to which inputted image each matrix corresponds can be added to the matrix stored in the matrix memory 13. Further, the image synthesis device can simultaneously carry out reduction, a filtering process, etc. on each of the inputted images when storing the inputted images in the image memory 12 so that the image synthesis unit 15 can handle the inputted images as a single inputted image when reading them.

When the image synthesis unit 15 completes the processes of steps ST7 and ST8 on all the pixels included in the vector graphic currently being drawn, the image synthesis unit 15 determines whether or not the drawing of all the graphic regions which the image synthesis unit has acquired by carrying out the region division on the outputted image (display screen) is completed and the creation of the outputted image is then completed (step ST9). When the creation of the outputted image is not completed (when NO in step ST9), the image synthesis unit repeatedly carries out the processes of steps ST3 to ST8. In contrast, when the creation of the outputted image is completed (when YES in step ST9), the display control unit 17 reads one frame of the data from the display memory 16, creates a synchronization signal which complies with the display unit, such as an LCD or a liquid crystal display, and produces a screen display (step ST10).

In addition, the image synthesis unit 15 determines whether or not there is a necessity to perform an image synthesis for the next frame (step ST11). At this time, when determining that there is a necessity to perform an image synthesis for the next frame (when YES in step ST11), the image synthesis unit repeatedly performs the processes of steps ST1 to ST10. In contrast, when determining that there is no necessity to perform an image synthesis for the next frame (when NO in step ST11), the image synthesis unit ends the image synthesizing processing.

Although the case in which the components of the image synthesis device 10 operate sequentially is shown as an example in the above-mentioned explanation for the convenience of explanation, each of the image memory 12 and the display memory 16 can be made to have a double buffer structure in order to improve the ability to synthesize images so that writing for input of an image into the image memory 12 and reading of an image for image synthesis from the image memory 12 can be performed in parallel and writing of the image synthesis result into the display memory 16 and reading of the image synthesis result for display from the display memory 16 can be performed in parallel, for example.

As mentioned above, the image synthesis device according to this Embodiment 1 includes the matrix memory 13 for storing matrix information for bringing subregions of each inputted image into correspondence with subregions of an outputted image in units of one graphic which forms the subregions, and the vector graphic processing unit 14 for receiving graphic data in a vector form defined by both vertex data each for defining the shape of one of a plurality of graphic regions into which the outputted image is divided, and drawing commands each for specifying the contents-to-be-drawn of corresponding vertex data, and for drawing a vector graphic of each of the graphic regions according to the graphic data, carries out a coordinate transformation process on each of the vector graphics drawn by the vector graphic processing unit 14 by using a correspondence defined by matrix information read from the matrix memory 13 to calculate the texture coordinates of each inputted image, and displays synthesized image data which the image synthesis device has calculated by using image element data about each inputted image, the image element data corresponding to the texture coordinates, on the screen of the display unit as the outputted image. By thus carrying out the image synthesis using the matrix information for bringing subregions of the outputted image into correspondence with subregions of each inputted image, the image synthesis device can reduce the memory capacity as compared with a case in which a mapping table in units of one pixel is used.

Further, even if the graphic data in a vector form are the one defined by both vertex data acquired by dividing the outputted image into a plurality of graphic regions each including a curved line as a part of its outline, and drawing commands each for specifying the contents-to-be-drawn of corresponding vertex data, the vector graphic processing unit 14 according to this Embodiment 1 divides the outline of each graphic region into minute line segments and draws the vector graphic of this graphic region. Thus, the region division is not limited to a typical one which uses triangles, rectangles or the like, and the display screen can be divided into regions by using vector graphics each including a curved line as a part of its outline. Therefore, the efficiency of the synthesizing processing can be increased according to the types of inputted images.

In addition, this Embodiment 1 can be easily implemented also for the use of superimposing vector graphics, such as characters in a font and a GUI (Graphical User Interface) screen, on an synthesized image acquired from images inputted from cameras and displays them on a single screen.

### Embodiment 2

Although in above-mentioned Embodiment 1 the case in which the image synthesis device 10 synthesizes a plurality of inputted images into a single image and displays this image is shown, the image synthesis device 10 also has a normal vector graphic drawing function, and can therefore display a vector graphic singly, or superimpose a vector graphic on a synthesized image.

Although an image synthesis device in accordance with this Embodiment 2 has the same structure as that according to above-mentioned Embodiment 1, the image synthesis device in accordance with this Embodiment 2 differs from that according to above-mentioned Embodiment 1 in that the image synthesis device displays a vector graphic singly or superimposes a vector graphic on a synthesized image. The structure of the image synthesis device in accordance with Embodiment 2 will be explained below by making reference to FIG. 1 shown in above-mentioned Embodiment 1. Hereafter, a case in which the image synthesis device superimposes a vector graphic (characters in a font) on a synthesized image will be explained as an example.

Next, the operation of the image synthesis device will be explained.

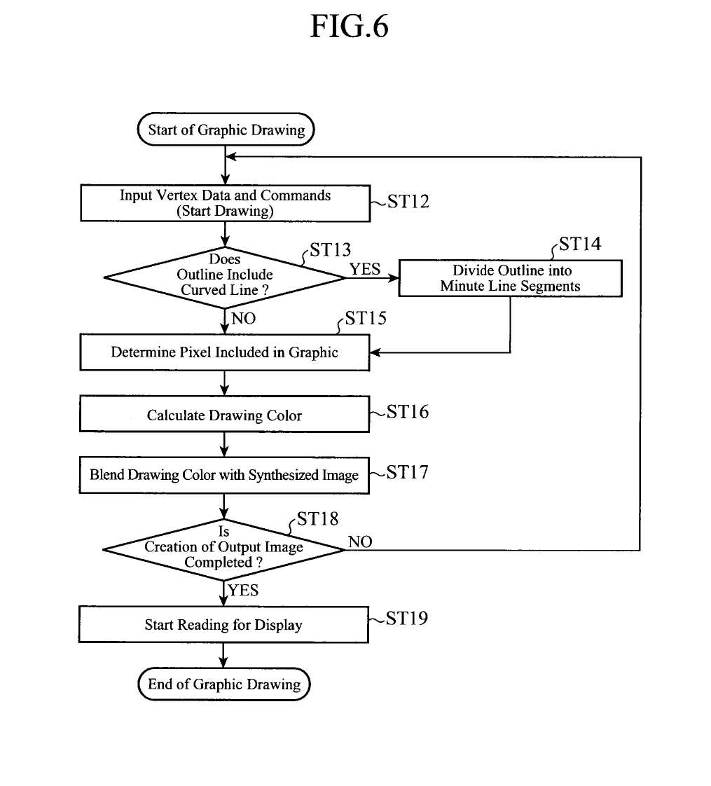

FIG. 6 is a flow chart showing a flow of the operation of the image synthesis device in accordance with Embodiment 2. The image synthesis device 10 starts the operation in response to a graphic drawing start command from a CPU of a system in which the image synthesis device 10 is mounted. It is assumed that at this time, the image synthesis device has completed the creation of a synthesized image in the same way that the image synthesis device according to above-mentioned Embodiment 1 does.

When the image synthesis device receives the above-mentioned graphic drawing start command, a vector graphic processing unit 14 receives graphic data in a vector form defined by both vertex data and a series of commands, and starts drawing each of vector graphics (step ST12). The vector graphic processing unit 14 determines whether the outline of the vector graphic includes a curved line (step ST13). When the outline of the vector graphic includes a curved line (when YES in step ST13), the vector graphic processing unit 14 divides the outline into minute line segments (step ST14).

When the outline does not include a curved line (when NO in step ST13), or after, in step ST14, dividing the outline into minute line segments, the image synthesis device can easily determine a region included in the vector graphic by using a typical method of determining whether or not a point is included in a graphic because the outline of the vector graphic is constructed of only straight lines. Therefore, the vector graphic processing unit 14 calculates the X and Y coordinates of each pixel included in the vector graphic, and outputs these X and Y coordinates to an image synthesis unit 15 (step ST15).

The image synthesis unit 15 determines a physical memory address and drawing data (drawing color) corresponding to the X and Y coordinates of each pixel inputted from the vector graphic processing unit 14 (step ST16). When filling in the vector graphic with a single color, the image synthesis unit outputs a fixed color as the drawing color, whereas when filling in the vector graphic with gradient colors, the image synthesis unit 15 handles the filling-in by interpolating the gradient colors.

Then, after the image synthesis unit 15 temporarily reads the synthesized image stored in a display memory 16 and carries out a blend arithmetic operation between the synthesized image and the drawing color, the image synthesis unit writes the synthesized image back to the display memory 16 (step ST17).

When the image synthesis unit 15 completes the processes of steps ST16 and ST17 on all the pixels included in the vector graphic currently being drawn, the image synthesis unit 15 determines whether or not the drawing of all the graphic regions which the image synthesis unit has acquired by carrying out the region division on the outputted image (display screen) is completed and the creation of the outputted image is then completed (step ST18).

When the creation of the outputted image is not completed (when NO in step ST18), the image synthesis unit repeatedly carries out the processes of steps ST12 to ST17. In contrast, when the creation of the outputted image is completed (when YES in step ST18), a display control unit 17 reads one frame of the data from the display memory 16, creates a synchronization signal which complies with a display unit, such as an LCD or a liquid crystal display, and produces a screen display (step ST19).

As mentioned above, in the image synthesis device according to this Embodiment 2, the vector graphic processing unit 14 has the mode in which the vector graphic processing unit is triggered by the completion of the capturing of inputted images by the image input unit 11 to start drawing each vector graphic, and the mode in which the vector graphic processing unit starts drawing each vector graphic according to a drawing start command from a CPU, like in the case of above-mentioned Embodiment 1, and the image synthesis unit 15 stores the result of carrying out a blend arithmetic operation between the synthesized image data stored in the display memory 16 and the vector graphic data drawn by the vector graphic processing unit 14 in the display memory 16 as synthesized image data. By doing in this way, the single image synthesis device can implement the two different functions including the image synthesis and the drawing of vector graphics. Therefore, the hardware scale of the image synthesis device can be reduced.

### INDUSTRIAL APPLICABILITY

Because the image synthesis device in accordance with the present invention can easily acquire a relationship between the image element positions of an outputted image and the image element positions of an inputted image while reducing the memory capacity without using a mapping table for each pixel, the image synthesis device in accordance with the present invention can be used suitably for an in-vehicle camera system, a monitoring camera system, etc.

1-6. (canceled)

7. An image synthesis device comprising:
an image input unit for capturing a plurality of images inputted thereto;
an image memory for storing the inputted images captured by said image input unit;
a matrix memory for storing matrix information for bringing subregions of each of said inputted images into correspondence with subregions of an outputted image in units of one graphic which forms said subregions;
a vector graphic processing unit for receiving a shape of each of a plurality of graphic regions which are the subregions of said outputted image into which said outputted image is divided as graphic data in a vector form defined by both vertex data and a drawing command for specifying contents-to-be-drawn of said vertex data, and for drawing a vector graphic of each of said graphic regions according to said graphic data;
an image synthesis unit for performing a coordinate transformation process on each image element included in the region of said vector graphic drawn by said vector graphic processing unit by using a correspondence defined by the matrix information read from said matrix memory, and for calculating image element positions corresponding to the subregion of said outputted image to calculate synthesized image data;
a display memory for storing a number of said synthesized image data calculated by said image synthesis unit, said number being equal to the number of said subregions into which said outputted image is divided; and
a display control unit for displaying said number of said synthesized image data read from said display memory on a screen of a display unit as said outputted image, wherein
said image synthesis unit stores a result of performing a blend arithmetic operation between the synthesized image data stored in said display memory and the vector graphic data drawn by said vector graphic processing unit as the synthesized image data in said display memory.

8. The image synthesis device according to claim 7, wherein said vector graphic processing unit has a mode in which said vector graphic processing unit is triggered by completion of the capturing of the inputted images by said image input unit to start drawing the vector graphic, and a mode in which said vector graphic processing unit starts drawing said vector graphic according to a drawing start command.

9. The image synthesis device according to claim 7, wherein said graphic data in the vector form is defined by the vertex data which are acquired by dividing said outputted image into the graphic regions each including a curved line as a part of its outline, and the drawing command for specifying the contents-to-be-drawn of said vertex data, and, when determining that each of said graphic regions includes a curved line as a part of its outline from said graphic data, said vector graphic processing unit divides said outline into minute line segments and draws the vector graphic of said graphic region.

10. The image synthesis device according to claim 7, wherein each of said image memory and said display memory has a double buffer structure, and said image synthesis device performs the storing of said inputted images in said image memory and the reading of the image element data from said image memory in parallel and performs the storing and the reading of the synthesized image data in and from said display memory in parallel.

11. A non-transitory computer readable medium including an image synthesis program for causing a computer to function as:
an image input unit for capturing a plurality of images inputted thereto;
an image memory for storing the inputted images captured by said image input unit;
a matrix memory for storing matrix information for bringing subregions of each of said inputted images into correspondence with subregions of an outputted image in units of one graphic which forms said subregions;
a vector graphic processing unit for receiving a shape of each of a plurality of graphic regions which are the subregions of said outputted image into which said outputted image is divided as graphic data in a vector form defined by both vertex data and a drawing command for specifying contents-to-be-drawn of said vertex data, and for drawing a vector graphic of each of said graphic regions according to said graphic data;
an image synthesis unit for performing a coordinate transformation process on each image element included in the region of said vector graphic drawn by said vector graphic processing unit by using a correspondence defined by the matrix information read from said matrix memory, and for calculating image element positions corresponding to the subregion of said outputted image to calculate synthesized image data;
a display memory for storing a number of said synthesized image data calculated by said image synthesis unit, said number being equal to the number of said subregions into which said outputted image is divided, said image synthesis unit storing a result of performing a blend arithmetic operation between the synthesized image data stored in said display memory and the vector graphic data drawn by said vector graphic processing unit as the synthesized image data in said display memory; and
a display control unit for displaying said number of said synthesized image data read from said display memory on a screen of a display unit as said outputted image.
